(19) United States
(12) Patent Application Publication
(10) Pub. No.: US 2016/0083544 A1
(43) Pub. Date: Mar. 24, 2016

(54) COMPOSITION FOR FIBER-REINFORCED COMPOSITE MATERIAL, PREPREG, AND FIBER-REINFORCED COMPOSITE MATERIAL

(71) Applicant: DAICEL CORPORATION, Osaka-shi, Osaka (JP)

(72) Inventors: Takuya OSAKA, Himeji-shi (JP); Tomoya MIZUTA, Himeji-shi (JP)

(73) Assignee: DAICEL CORPORATION, Osaka-shi, Osaka (JP)

(21) Appl. No.: 14/893,460

(22) PCT Filed: May 22, 2014
(86) PCT No.: PCT/JP2014/063553

§ 371 Date: Nov. 23, 2015

(30) Foreign Application Priority Data
May 24, 2013 (JP) 2013-110038

(51) Int. Cl. C08J 5/24; C08J 5/04

(52) U.S. Cl. CPC C08J 5/24; C08J 5/04; C08J 2335/02; C08J 2463/00

(57) ABSTRACT

An object of the present invention is to provide a composition for a fiber-reinforced composite material, the composition being capable of forming the fiber-reinforced composite material excellent in work stability, high in curing speed and high in heat resistance, and particularly suitable for production of a continuous fiber-reinforced composite material by a pultrusion method.

The present invention relates to the composition for a fiber-reinforced composite material, the composition containing a radically polymerizable compound (A), a cationically polymerizable compound (B), a compound (C) having a radically polymerizable group and a cationically polymerizable group in one molecule thereof, a radical polymerization initiator (D), an acid generator (E), and a release agent (F), wherein the radically polymerizable compound (A) is a compound having not less than two radically polymerizable groups in one molecule thereof, and having a functional group equivalent weight of the radically polymerizable group of 50 to 300.

### TECHNICAL FIELD

The present invention relates to a composition for a fiber-reinforced composite material, a prepreg, and a fiber-reinforced composite material. The present invention relates particularly to a composition for forming a composite material (composite material of fibers with a resin) reinforced with the fibers (reinforcing fibers) such as carbon fibers and glass fibers, a prepreg, and the composite material (fiber-reinforced composite material). The present application claims priority to Japanese Patent Application No. 2013-110038, filed on May 24, 2013, the entire contents of which are hereby incorporated by reference.

### BACKGROUND ART

Fiber-reinforced composite materials are composite materials composed of reinforcing fibers with a resin (matrix resin), and are broadly utilized in the fields of automobile parts, civil engineering and construction supplies, blades for wind power generators, sports goods, aircrafts, marine vessels, robots, cable materials and the like. As reinforcing fibers in the fiber-reinforced composite materials, there are used, for example, glass fibers, aramid fibers, carbon fibers and boron fibers. Further as matrix resins in the fiber-reinforced composite materials, there are often used thermosetting resins easily impregnated into reinforcing fibers. As such thermosetting reins, there are used, for example, epoxy resins, unsaturated polyester resins, vinyl ester resins, phenol resins, maleimide resins and cyanate resins.

As a material for forming the fiber-reinforced composite material, there is known, for example, a prepreg, for a composite material that contains a thermosetting resin composition containing a benzoxazine resin, an acid catalyst and a flame-retardant reinforcing fiber (see Patent Literature 1). There is also known, for example, a thermosetting resin composition containing a phenol resol resin, and an etherified phosphate ester latent catalyst selected from the group consisting of a phosphate ester of an alkoxylated polyol and a phosphate ester of a monoepoxy functional diluent (see Patent Literature 2).

### CITATION LIST

### Patent Literature

### Patent Literature 1: Japanese Patent Laid-Open No. 2008-56795

### Patent Literature 2: Japanese Patent Laid-Open No. 2008-507620

### SUMMARY OF INVENTION

### Technical Problem

The prepreg for a composite material disclosed in Patent Literature 1, however, has the problem of slow curing since the prepreg contains a benzoxazine resin. Further the thermosetting resin composition disclosed in Patent Literature 2 has the problem of the short pot life due to its very high curing speed, resulting in that the work stability is inferior.

Hence, it is the present situation that there are still obtained no compositions (compositions for fiber-reinforced composite materials) which, as materials for forming fiber-reinforced composite materials, have a sufficient pot life and therefore an excellent work stability, and can quickly progress the curing reaction when being cured. Although particularly in recent years, along with the expansion of applications of fiber-reinforced composite materials, the high heat resistance (for example, a heat resistance capable of withstanding use under an environment of as high a temperature as 200° C.) comes to be demanded, there can be still obtained no compositions which can form fiber-reinforced composite materials having such a high heat resistance, are excellent in the work stability, and exhibit a high curing speed.

On the other hand, fiber-reinforced composite materials are often produced by pultrusion methods in which molding is carried out while compositions for the fiber-reinforced composite materials are cured at high speeds. In the case of using known compositions for fiber-reinforced composite materials as a raw material, however, the releasability from molds of the fiber-reinforced composite materials obtained by curing and molding is insufficient, and there arises the problem of increasing the pulling stress during molding, resulting in that continuous molding then becomes difficult.

Therefore, an object of the present invention is to provide a composition for a fiber-reinforced composite material, which is capable of forming the fiber-reinforced composite material excellent in work stability, high in curing speed, and high in heat resistance, and is suitable particularly for the production of a continuous fiber-reinforced composite material by a pultrusion method.

Further, another object of the present invention is to provide a prepreg which is capable of forming the fiber-reinforced composite material excellent in work stability, high in curing speed, and high in heat resistance, and is suitable particularly for the production of a continuous fiber-reinforced composite material by a pultrusion method.

Yet another object of the present invention is to provide a fiber-reinforced composite material which is excellent in productivity, and high in heat resistance, and is capable of being continuously produced by a pultrusion method.

### Solution to Problem

As a result of diligent studies to solve the above-mentioned problem, the present inventors have found that a composition containing, at least, a specific radically polymerizable compound, cationically polymerizable compound, compound having a radically polymerizable group and cationically polymerizable group in one molecule thereof, radical polymerization initiator, acid generator and release agent is capable of forming a fiber-reinforced composite material excellent in work stability, high in curing speed and further high in heat resistance, and suitable particularly for the production of a continuous fiber-reinforced composite material by a pultrusion method; and this finding has led to the completion of the present invention.

That is, the present invention provides a composition for a fiber-reinforced composite material, which composition contains a radically polymerizable compound (A), a cationically polymerizable compound (B), a compound (C) having a radically polymerizable group and a cationically polymerizable group in one molecule thereof, a radical polymerization initiator (D), an acid generator (E) and a release agent (F), wherein the radically polymerizable compound (A) is a compound having not less than two radically polymerizable groups in one molecule thereof, and having a functional group equivalent weight of the radically polymerizable groups of 50 to 300.

The present invention further provides the composition for a fiber-reinforced composite material, wherein the cationically polymerizable compound (B) is at least one compound selected from the group consisting of epoxy compounds, oxetane compounds and vinyl ether compounds.

The present invention further provides the composition for a fiber-reinforced composite material, wherein the cationically polymerizable compound (B) is an alicyclic epoxy compound.

The present invention further provides the composition for a fiber-reinforced composite material, wherein the cationically polymerizable compound (B) is a compound having not less than two cationically polymerizable groups in one molecule thereof, and having a functional group equivalent weight of the cationically polymerizable groups of 50 to 300.

The present invention further provides the composition for a fiber-reinforced composite material, wherein the proportion (weight ratio) [(A)/(B)] of the radically polymerizable compound (A) to the cationically polymerizable compound (B) is 30/70 to 85/15.

The present invention further provides the composition for a fiber-reinforced composite material, wherein the radically polymerizable compound (A) contains an alkylene oxide-modified monomer having not less than four radically polymerizable groups in one molecule thereof.

The present invention further provides the composition for a fiber-reinforced composite material, wherein the compound (C) is a compound having a functional group equivalent weight of the cationically polymerizable group of 50 to 500, and a functional group equivalent weight of the radically polymerizable group of 50 to 500.

The present invention further provides the composition for a fiber-reinforced composite material, wherein the content of the compound (C) is 10 to 70 parts by weight based on 100 parts by weight of the total amount of the radically polymerizable compound (A) and the cationically polymerizable compound (B).

The present invention further provides the composition for a fiber-reinforced composite material, wherein the content of the radical polymerization initiator (D) is 0.01 to 10 parts by weight based on 100 parts by weight of the total amount of the radically polymerizable compound (A), the cationically polymerizable compound (B) and the compound (C).

The present invention further provides the composition for a fiber-reinforced composite material, wherein the content of the acid generator (E) is 0.1 to 20 parts by weight based on 100 parts by weight of the total amount of the radically polymerizable compound (A), the cationically polymerizable compound (B) and the compound (C).

The present invention further provides the composition for a fiber-reinforced composite material, wherein the content of the release agent (F) is 1 to 8 parts by weight based on 100 parts by weight of the total amount of the components (A) to (E).

The present invention further provides the composition for a fiber-reinforced composite material, wherein the release agent (F) is a higher fatty acid having 10 to 30 carbon atoms or a derivative thereof.

The present invention further provides the composition for a fiber-reinforced composite material, wherein the release agent (F) is a metal stearate compound.

The present invention further provides the composition for a fiber-reinforced composite material, wherein the elastic modulus E′ at 250° C. of a cured material obtained by curing the composition is not less than 1×10⁸ Pa.

The present invention further provides the composition for a fiber-reinforced composite material, wherein the reduction rate of the elastic modulus E′ of a cured material obtained by curing the composition as calculated by the following expression is not more than 50%.

A reduction rate of the elastic modulus (%)=100×(a−b)/a

wherein a represents an elastic modulus (Pa) of the cured material at a temperature (° C.) of (the glass transition temperature thereof−10° C.); and b represents an elastic modulus (Pa) of the cured material at a temperature (° C.) of (the glass transition temperature thereof+10° C.)

The present invention further provides the composition for a fiber-reinforced composite material, wherein the degree of curing [which is measured by differential scanning calorimetry] of a cured material obtained by curing the composition by a heat treatment at 220° C. for 2 min is not less than 80%.

The present invention further provides a prepreg to be formed by impregnating the composition for a fiber-reinforced composite material into a reinforcing fiber (G).

The present invention further provides the prepreg, wherein the fiber mass content rate (Wf) of the reinforcing fiber (G) is 50 to 90% by weight.

The present invention further provides the prepreg, wherein the reinforcing fiber (G) is at least one selected from the group consisting of carbon fibers, glass fibers and aramid fibers.

The present invention further provides a fiber-reinforced composite material which is obtained by curing the prepreg.

### Advantageous Effects of Invention

The composition for a fiber-reinforced composite material and the prepreg according to the present invention are excellent in work stability, and is capable of being cured at a high speed on being cured (that is, the curing speed is high), since having the above constitutions. Further the composition for a fiber-reinforced composite material and the prepreg according to the present invention can form a fiber-reinforced composite material having a high heat resistance. Further in the case of using the composition for a fiber-reinforced composite material and the prepreg according to the present invention, even in the case of carrying out molding by a pultrusion method, an increase in the pulling stress is hardly caused and the continuous production of the fiber-reinforced composite material is possible. Hence, the fiber-reinforced composite material obtained by curing the composition for a fiber-reinforced composite material or the prepreg according to the present invention is excellent in production and high in heat resistance.

### DESCRIPTION OF EMBODIMENTS

### <Composition for a Fiber-Reinforced Composite Material>

The composition for a fiber-reinforced composite material (sometimes referred to simply as “composition according to the present invention” or “composition”) according to the present invention is a composition (curable composition) containing, at least, a radically polymerizable compound (A), a cationically polymerizable compound (B), a compound (C) having a radically polymerizable group and a cationically polymerizable group in one molecule thereof (sometimes referred to simply as “compound (C)”), a radical polymerization initiator (D), an acid generator (E) and a release agent (F).

### [Radically Polymerizable Compound (A)]

The radically polymerizable compound (A) in the composition according to the present invention is a compound having not less than two radically polymerizable groups in one molecule thereof. Here, the radically polymerizable compound (A) does not include one having a radically polymerizable group, and further having a cationically polymerizable group (that is, a compound (C)).

The radically polymerizable group of the radically polymerizable compound (A) is not especially limited as long as being a functional group capable of causing a radical polymerization reaction, but examples thereof include groups containing a carbon-carbon unsaturated double bond, and specific examples thereof include a vinyl group, and a (meth)acryloyl group. Here, not less than two radically polymerizable groups of the radically polymerizable compound (A) may be identical or different from each other. “(Meth)acryloyl” herein means “acryloyl” and/or “methacryloyl” (either “acryloyl” or “methacryloyl”, or both); and the same also applies to other (meth)-related nomenclatures.

The number of the radically polymerizable groups in one molecule of the radically polymerizable compound (A) is not especially limited as long as being not less than two, but 2 or 20 groups is preferable; 2 to 15 groups is more preferable; and 2 to 10 groups is still more preferable.

Specific examples of the radically polymerizable compound (A) include vinyl compounds such as divinylbenzene; and (meth)acrylates such as ethylene glycol di(meth)acrylate, triethylene glycol di(meth)acrylate, 1,3-butanediol di(meth)acrylate, 1,4-butanediol di(meth)acrylate, tetramethylene glycol di(meth)acrylate, propylene glycol di(meth)acrylate, neopentyl glycol di(meth)acrylate, tetraethylene glycol di(meth)acrylate, bisphenol A epoxy di(meth)acrylate, 9,9-bis[(4-(2-(meth)acryloyloxyethoxy)phenyl)]fluorene, nonanediol di(meth)acrylate, diethylene glycol di(meth)acrylate, polyethylene glycol di(meth)acrylate, polypropylene glycol di(meth)acrylate, polytetramethylene glycol di(meth)acrylate, pentaerythritol di(meth)acrylate, dipentaerythritol di(meth)acrylate, dimethyloldicyclopentane di(meth)acrylate (tricyclodecanedimethanol di(meth)acrylate), alkylene oxide-modified bisphenol A (meth)acrylates (for example, ethoxylated(ethylene oxide-modified)bisphenol A di(meth)acrylates), trimethylolpropane tri(meth)acrylate, trimethylolethane tri(meth)acrylate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, dipentaerythritol hexa(meth)acrylate, alkylene oxide-modified pentaerythritol(meth)acrylates (for example, ethoxylated(ethylene oxide-modified)pentaerythritol tetra(meth)acrylates), alkylene oxide-modified dipentaerythritol(meth)acrylates (for example, ethoxylated(ethylene oxide-modified)dipentaerythritol hexa(meth)acrylates), 2,2,2-tris(meth)acryloyloxymethyl ethyl succinate, alkylene oxide-modified isocyanuric acid (di or tri)(meth)acrylates (for example, ethoxylated (ethylene oxide-modified) isocyanuric acid tri(meth)acrylates, and urethane(meth)acrylates.

Among these, as the radically polymerizable compound (A), preferable are a radically polymerizable compound (A-1) having two radically polymerizable groups in one molecule thereof and a cyclic structure (an aromatic ring, alicyclic ring, a hetero ring and the like) in its molecule, and a radically polymerizable compound (A-2) having not less than three radically polymerizable groups in one molecule thereof. The compound (A-1) specifically includes radically polymerizable compounds such as divinylbenzene, bisphenol A epoxy di(meth)acrylate, 9,9-bis[(4-(2-(meth)acryloyloxyethoxy)phenyl)]fluorene, dimethyloldicyclopentane di(meth)acrylate and alkylene oxide-modified bisphenol A di(meth)acrylates (for example, ethoxylated bisphenol A di(meth)acrylates). Further the compounds (A-2) specifically include trimethylolpropane tri(meth)acrylate, trimethylolethane tri(meth)acrylate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, dipentaerythritol hexa(meth)acrylate, alkylene oxide-modified pentaerythritol (tri or tetra)(meth)acrylates (for example, ethoxylated(ethylene oxide-modified)pentaerythritol tetra(meth)acrylates), alkylene oxide-modified dipentaerythritol (tri, tetra, penta or hexa)(meth)acrylates (for example, ethoxylated (ethylene oxide-modified)dipentaerythritol hexa(meth)acrylates), 2,2,2-tris(meth)acryloyloxymethyl ethyl succinate, alkylene oxide-modified isocyanuric acid tri(meth)acrylates (for example, ethoxylated isocyanuric acid tri(meth)acrylates), and urethane(meth)acrylates having not less than three (meth)acryloyl groups in one molecule thereof.

Particularly as the radically polymerizable compound (A), from the viewpoint of the heat resistance and the elastic modulus of the cured material and the fiber-reinforced composite material, concurrent use of the above compound (A-1) and the above compound (A-2) is preferable. The compound (A-1) and the compound (A-2) each may be used singly or may be used in a combination of two or more thereof.

The functional group equivalent weight of the radically polymerizable group of the radically polymerizable compound (A) is 50 to 300, preferably 70 to 280, and more preferably 80 to 260. When the functional group equivalent weight is less than 50, the mechanical strength of the cured material and the fiber-reinforced composite material becomes insufficient. By contrast, when the functional group equivalent weight is more than 300, the heat resistance and the mechanical properties of the cured material and the fiber-reinforced composite material decrease. Here, the functional group equivalent weight of the radically polymerizable group of the radically polymerizable compound (A) can be calculated from the following expression.

[A functional group equivalent weight of a radically polymerizable group]=[a molecular weight of a radically polymerizable compound (A)]/[the number of the radically polymerizable group of the radically polymerizable compound (A)]

Here, in the composition according to the present invention, the radically polymerizable compound (A) can be used singly or can be used in a combination of not less than two thereof. Further as the radically polymerizable compound (A), there can also be used commercially available products, for example, “IRR214-K” by trade name (dimethyloldicyclopentane diacrylate, manufactured by Daicel-Cytec Co., Ltd.), “A-BPE-4” by trade name (ethoxylated bisphenol A diacrylate, manufactured by Shin-Nakamura Chemical Co., Ltd.), “A-9300” by trade name (ethoxylated isocyanuric acid triacrylate, manufactured by Shin-Nakamura Chemical Co., Ltd.), “A-TMM-3” by trade name (pentaerythritol triacrylate, manufactured by Shin-Nakamura Chemical Co., Ltd.), “DPHA” by trade name (dipentaerythritol hexaacrylate, manufactured by Daicel-Cytec Co., Ltd.), “KRM8452” by trade name (aliphatic urethane acrylate, manufactured by Daicel-Cytec Co., Ltd.), “A-DPH-12E” by trade name (ethoxylated dipentaerythritol hexaacrylate, manufactured by Shin-Nakamura Chemical Co., Ltd.), and “A-9570W” by trade name (dipentaerythritol pentaacrylate, manufactured by Shin-Nakamura Chemical Co., Ltd.).

The content (blend amount) of the radically polymerizable compound (A) in the composition according to the present invention is not especially limited, but is, based on the total amount (100% by weight) of the composition (composition for a fiber-reinforced composite material), preferably 10 to 75% by weight, more preferably 30 to 65% by weight, and still more preferably 35 to 60% by weight. When the content is less than 10% by weight, the curing speed decreases and the heat resistance of a cured material decreases in some cases. By contrast, when the content is more than 75% by weight, the interfacial strength of a cured material and fibers decreases in some cases. Here, in the case of concurrently using not less than two radically polymerizable compounds (A), it is preferable that the total amount of the radically polymerizable compounds (A) be controlled in the above range.

In the case of concurrently using the above compound (A-1) and the above compound (A-2) as the radically polymerizable compound (A), the proportion (weight ratio)[(A-1)/(A-2)] of these compounds is not especially limited, but is preferably 40/60 to 90/10, and more preferably 50/50 to 85/15 from the viewpoint of the heat resistance and the elastic modulus of the cured material and the fiber-reinforced composite material.

In the composition according to the present invention, it is preferable particularly from the viewpoint of improving the toughness of the cured material that the radically polymerizable compound (A) (radically polymerizable compound (A-2)) contain an alkylene oxide-modified monomer having not less than four radically polymerizable groups in one molecule thereof (sometimes referred to simply as “alkylene oxide-modified monomer”). The alkylene oxide-modified monomer is a monomer having not less than four radically polymerizable groups in one molecule thereof and at least having a constituting unit (constituting unit formed by a ring-opening addition reaction of an alkylene oxide)(particularly a repeating constituting unit) originated from the alkylene oxide. Here, the alkylene oxide-modified monomer may be used singly or may be used in a combination of two or more thereof. The incorporation of the alkylene oxide-modified monomer to the composition according to the present invention enables the toughness of the cured material to be improved while maintaining the high glass transition temperature thereof, and the reason of this is presumably because that the alkylene oxide-modified monomer has many radically polymerizable groups and has a chain structure extended by constituting units originated from the alkylene oxide.

Examples of the alkylene oxide-modified monomer include a compound represented by the following formula (1).

[Formula 1]

R¹OR²O_{q}R³]ᵣ (1)

In the formula (1), R¹ is, on the constitutional formula, an r-valent organic group (residue) formed by removing r hydroxyl groups from an organic compound having the r hydroxyl groups. r represents an integer of not less than 4 (for example, an integer of 4 to 10). Examples of the organic compound having r hydroxyl groups include compounds (alcohols, phenols and the like) having not less than four hydroxyl groups in one molecule thereof. Specific examples of the alcohols include polyhydric alcohols such as diglycerol, polyglycerol, pentaerythritol and dipentaerythritol. Specific examples of the phenols include phenol novolac resins, and cresol novolac resins. Further examples of the organic compound having r hydroxyl groups include polyvinyl alcohol, partial hydrolyzates of polyvinyl acetate, starch, acrylpolyol resins, styrene-ally alcohol copolymer resins, polyesterpolyol resins, polycaprolactonepolyol resins, polypropylenepolyol, polycarbonatepolyols, polybutadienes having hydroxyl groups, and cellulose polymers such as cellulose, cellulose acetate, cellulose acetate butyrate and hydroxyethyl cellulose. In the above formula (1), q represents integers of 0 to 10. Provided that the total of q in the formula (1) is an integer of not less than 1 (for example, an integer of 1 to 20). Among these, it is preferable that a plurality of q in the formula (1) be each an integer of not less than 1. Here, the plurality of q in the formula (1) may be identical or different.

In the formula (1), R² represents a straight-chain or branched-chain alkylene group. Examples of the straight-chain or branched-chain alkylene group include straight-chain or branched-chain alkylene groups having 1 to 10 carbon atoms such as a methylene group, a methylmethylene group, a dimethylmethylene group, an ethylene group, a propylene group, a trimethylene group and a pentylene group. Among these, an ethylene group and a propylene group are preferable. Here, in the case where a plurality of R² are present in the formula (1), these R² may be identical or different.

In the formula (1), R³ are identical or different, and represent a radically polymerizable group (including a group containing a radically polymerizable group) or a hydrogen atom. Provided that out of R³ in the formula (1), at least four thereof are radically polymerizable groups. The radically polymerizable groups include the groups exemplified in the above-mentioned paragraph of the radically polymerizable compound (A), and examples thereof include a (meth)acryloyl group.

Specific examples of the radically polymerizable compound (A), which is a compound represented by the formula (1), include alkylene oxide-modified pentaerythritol tetra(meth)acrylates (for example, ethoxylated(ethylene oxide-modified)pentaerythritol tetra(meth)acrylates); and alkylene oxide-modified (tetra, penta or hexa)dipentaerythritol(meth)acrylates (for example, ethoxylated(ethylene oxide-modified)dipentaerythritol hexa(meth)acrylates).

The compound represented by the formula (1) can be produced, for example, but not especially limited to, by subjecting an organic compound having r hydroxyl groups to an addition reaction (ring-opening addition reaction) with an alkylene oxide, and then incorporating radically polymerizable groups. A method of the addition reaction with the alkylene oxide is not especially limited, and a known or common method can be employed. A method of incorporating radically polymerizable groups is not especially limited, and a known or common method can be applied. Examples thereof include a method in which a (meth)acrylic acid derivative or the like is allowed to react with terminal hydroxyl groups produced by the ring-opening addition of an alkylene oxide.

The content (blend amount) of the alkylene oxide-modified monomer (total amount) in the composition according to the present invention is not especially limited, but is, based on the total amount (100% by weight) of the radically polymerizable compound (A) and the cationically polymerizable compound (B), preferably 5 to 70% by weight, more preferably 10 to 60% by weight, and still more preferably 15 to 50% by weight. When the content of the alkylene oxide-modified monomer is less than 5% by weight, the effect of imparting the toughness to the cured material and the fiber-reinforced composite material becomes insufficient in some cases. By contrast, when the content of the alkylene oxide-modified monomer is more than 70% by weight, the heat resistance of the cured material and the fiber-reinforced composite material decreases in some cases.

Here, the composition according to the present invention may contain a radically polymerizable compound other than the radically polymerizable compound (A). Examples of the radically polymerizable compound other than the radically polymerizable compound (A) include compounds having one radically polymerizable group in one molecule thereof, compounds having a functional group equivalent weight of the radically polymerizable group of less than 50, and compounds having a functional group equivalent weight of the radically polymerizable group of more than 300. Examples of the compounds having one radically polymerizable group in one molecule thereof include vinyl compounds such as styrene, 2-chlorostyrene, 2-bromostyrene, methoxystyrene, 1-vinylnaphthalene and 2-vinylnaphthalene; and (meth)acrylates such as 2-phenoxyethyl(meth)acrylate, benzyl(meth)acrylate, o-phenylphenol(meth)acrylate, nonylphenoxypolyethylene glycol(meth)acrylate, tetrahydrofurfuryl(meth)acrylate, triethylene glycol mono(meth)acrylate, 1,3-butanediol mono(meth)acrylate, tetramethylene glycol mono(meth)acrylate, propylene glycol mono(meth)acrylate (for example, 1,2-propanediol-1-(meth)acrylate), neopentyl glycol mono(meth)acrylate, methoxypolyethylene glycol(meth)acrylate, dicyclopentenyl(meth)acrylate, dicyclopentenyloxyethyl(meth)acrylate, dicyclopentanyl(meth)acrylate, pentamethylpiperidinyl(meth)acrylate, tetramethylpiperidinyl(meth)acrylate, and tetrahydrofurfuryl(meth)acrylate. These may be used singly or may be used in a combination of two or more thereof.

### [Cationically Polymerizable Compound (B)]

The cationically polymerizable compound (B) in the composition according to the present invention is a compound having not less than one cationically polymerizable group in one molecule thereof. Here, the cationically polymerizable compound (B) does not include one having a cationically polymerizable group and further having a radically polymerizable group (that is, a compound (C)).

The cationically polymerizable group of the cationically polymerizable compound (B) is not especially limited as long as being a functional group capable of causing a cationic polymerization reaction, but examples thereof include an epoxy group, an oxetanyl group and a vinyl ether group. Here, when the cationically polymerizable compound (B) has not less than two cationically polymerizable groups, these cationically polymerizable groups may be identical or different from each other.

The number of the cationically polymerizable group in one molecule of the cationically polymerizable compound (B) is not especially limited as long as being not less than one, but is preferably not less than two, more preferably 2 to 20, still more preferably 2 to 15, and especially preferably 2 to 10.

Examples of the cationically polymerizable compound (B) include epoxy compounds (compounds having not less than one epoxy group in one molecule thereof), oxetane compounds (compounds having not less than one oxetanyl group in one molecule thereof), and vinyl ether compounds (compounds having not less than one vinyl ether group in one molecule thereof).

Specific examples of the epoxy compound include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, biphenol diglycidyl ether, tetramethylbiphenol diglycidyl ether, naphthalenediol diglycidyl ether, bisphenolfluorene diglycidyl ether, biscresolfluorene diglycidyl ether, bisphenoxyethanolfluorene diglycidyl ether, hydrogenated bisphenol A diglycidyl ethers, hydrogenated bisphenol F diglycidyl ether, hydrogenated bisphenol S diglycidyl ethers, 3,4,3′,4′-diepoxybicyclohexyl, 3,4-epoxycyclohexylmethyl(3,4-epoxy)cyclohexanecarboxylate, 2-(3,4-epoxycyclohexyl-5,5-spiro-3,4-epoxy)cyclohexane-meta-dioxane, bis(3,4-epoxycyclohexylmethyl) adipate, bis(3,4-epoxy-6-methylcyclohexylmethyl) adipate, 3,4-epoxy-6-methylcyclohexyl-3′,4′-epoxy-6′-methylcyclohexanecarboxylate, methylenebis(3,4-epoxycyclohexane), dicyclopentadiene diepoxide, di(3,4-epoxycyclohexylmethyl) ether of ethylene glycol, ethylene bis(3,4-epoxycyclohexanecarboxylate), 2,2-bis(3,4-epoxycyclohexyl)propane, 2,2-bis(3,4-epoxycyclohexyl)-1,3-hexafluoropropane, bis(3,4-epoxycyclohexyl)methane, 1-[1,1-bis(3,4-epoxycyclohexyl)]ethylbenzene, cyclohexene oxide, 3,4-epoxycyclohexylmethyl alcohol, 3,4-epoxycyclohexylethyltrimethoxysilane, dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ethers and polypropylene glycol diglycidyl ethers; polyglycidyl ethers of polyether polyols obtained by adding one or not less than two alkylene oxides to aliphatic polyhydric alcohols such as ethylene glycol, propylene glycol and glycerol; diglycidyl esters of aliphatic long-chain dibasic acids; monoglycidyl ethers of aliphatic higher alcohols; monoglycidyl ethers of polyether alcohols obtained by adding alkylene oxides to phenol, cresol, butyiphenol or these; mon- or polyglycidyl ethers of polyether alcohols obtained by adding alkylene oxides to phenols having not less than two hydroxyl groups in one molecule, such as catechol, pyrogallol, hydroquinone, bisphenol A, bisphenol F, 4,4′-dihydroxybenzophenone and bisphenol S; and glycidyl esters of higher fatty acids.

Specific examples of the oxetane compound include 3,3-bis(vinyloxymethyl)oxetane, 3-ethyl-3-(2-ethylhexyloxymethyl)oxetane, 3-ethyl-3-(hydroxymethyl)oxetane, 3-ethyl-3-[(phenoxy)methyl]oxetane, 3-ethyl-3-(hexyloxymethyl)oxetane, 3-ethyl-3-(chloromethyl)oxetane, 3,3-bis(chloromethyl)oxetane, bis{[1-ethyl(3-oxetanyl)]]methyl}ether, 4,4′-bis[(3-ethyl-3-oxetanyl)methoxymethyl]bicyclohexyl, 1,4-bis[(3-ethyl-3-oxetanyl)methoxymethyl)]cyclohexane, 1,4-bis{[((3-ethyl-3-oxetanyl)methoxy]methyl}benzene, 3-ethyl-3-{[(3-ethyloxetan-3-yl)methoxy]methyl}oxetane, xylylene bisoxetane, 3-ethyl-3-{[3-(triethoxysilyl)propoxy]methyl}oxetane, oxetanylsilsesquioxane, and phenol novolac oxetanes.

Specific examples of the vinyl ether compound include 2-hydroxyethyl vinyl ether, 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,6-hexanediol divinyl ether, 1,4-cyclohexanedimethanol monovinyl ether, 1,4-cyclohexanedimethanol divinyl ether, 1,3-cyclohexanedimethanol monovinyl ether, 1,3-cyclohexanedimethanol divinyl ether, 1,2-cyclohexanedimethanol monovinyl ether, 1,2-cyclohexanedimethanol divinyl ether, p-xylene glycol monovinyl ether, p-xylene glycol divinyl ether, m-xylene glycol monovinyl ether, m-xylene glycol divinyl ether, o-xylene glycol monovinyl ether, o-xylene glycol divinyl ether, diethylene glycol monovinyl ether, diethylene glycol divinyl ether, triethylene glycol monovinyl ether, triethylene glycol divinyl ether, tetraethylene glycol monovinyl ether, tetraethylene glycol divinyl ether, pentaethylene glycol monovinyl ether, pentaethylene glycol divinyl ether, oligoethylene glycol monovinyl ethers, oligoethylene glycol divinyl ethers, polyethylene glycol monovinyl ethers, polyethylene glycol divinyl ethers, dipropylene glycol monovinyl ether, dipropylene glycol divinyl ether, tripropylene glycol monovinyl ether, tripropylene glycol divinyl ether, tetrapropylene glycol monovinyl ether, tetrapropylene glycol divinyl ether, pentapropylene glycol monovinyl ether, pentapropylene glycol divinyl ether, oligopropylene glycol monovinyl ethers, oligopropylene glycol divinyl ethers, polypropylene glycol monovinyl ethers, polypropylene glycol divinyl ethers, isosorbide divinyl ether, oxanorbornene divinyl ether, phenyl vinyl ether, n-butyl vinyl ether, octyl vinyl ether, cyclohexyl vinyl ether, hydroquinone divinyl ether, 1,4-butanediol divinyl ether, and cyclohexanedimethanol divinyl ether.

Among these, as the cationically polymerizable compound (B), from the viewpoint of the curing speed, and the heat resistance of the cured material and the fiber-reinforced composite material, preferable are epoxy compounds (referred to as “alicyclic epoxy compounds) having not less than one alicyclic structure and not less than one epoxy group in one molecule thereof. Specific examples of the alicyclic epoxy compounds include (i) compounds having an epoxy group (alicyclic epoxy group) constituted of two adjacent carbon atoms constituting an aliphatic ring and an oxygen atom, and (ii) compounds in which an epoxy group is bonded through a single bond directly to an aliphatic ring.

As the above (i) compounds having an epoxy group (alicyclic epoxy group) constituted of two adjacent carbon atoms constituting an aliphatic ring and an oxygen atom, known or common ones can be optionally selected and used. Particularly as the alicyclic epoxy group, preferable is a group (cyclohexene oxide group) constituted of two adjacent carbon atoms constituting a cyclohexane ring and an oxygen atom.

As the above (i) compounds having an epoxy group (alicyclic epoxy group) constituted of two adjacent carbon atoms constituting an aliphatic ring and an oxygen atom, from the viewpoint of the curing speed, and the heat resistance of the cured material and the fiber-reinforced composite material, preferable is particularly a compound (alicyclic epoxy compound) represented by the following formula (I).

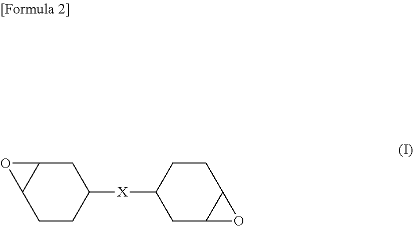

In the formula (I), X represents a single bond or a linkage group (a divalent group having not less than one atom). Examples of the linkage group include divalent hydrocarbon groups, alkenylene groups in which a part of or the whole of carbon-carbon double bonds is epoxidated, a carbonyl group, an ether bond, an ester bond, a carbonate group, an amido group, and groups in which a plurality thereof are linked.

The divalent hydrocarbon groups include straight-chain or branched-chain alkylene groups having 1 to 18 carbon atoms, and divalent alicyclic hydrocarbon groups. Examples of the straight-chain or branched-chain alkylene groups having 1 to 18 carbon atoms include a methylene group, a methylmethylene group, a dimethylmethylene group, an ethylene group, a propylene group and a trimethylene group. Examples of the divalent alicyclic hydrocarbon groups include divalent cycloalkylene groups (including cycloalkylidene groups) such as a 1,2-cyclopentylene group, a 1,3-cyclopentylene group, a cyclopentylidene group, a 1,2-cyclohexylene group, a 1,3-cyclohexylene group, a 1,4-cyclohexylene group, and a cyclohexylidene group.

Examples of alkenylene groups in the alkenylene groups (sometimes referred to simply as “epoxidated alkenylene groups) in which a part of or the whole of carbon-carbon double bonds is epoxidated include straight-chain or branched-chain alkenylene groups having 2 to 8 carbon atoms such as a vinylene group, a propenylene group, a 1-butenylene group, 2-butenylene group, a butadienylene group, a pentenylene group, a hexenylene group, a heptenylene group and an octenylene group. Particularly as the epoxidated alkenylene groups, preferable are alkenylene groups in which the whole of carbon-carbon double bonds is epoxidated; and more preferable are alkenylene groups having 2 to 4 carbon atoms in which the whole of carbon-carbon double bonds is epoxidated.

As the linkage group X, particularly linkage groups containing an oxygen atom are preferable; and the linkage groups specifically include —CO—, —O—CO—O—, —COO—, —O—, —CONH—, epoxidated alkenylene groups; groups in which a plurality thereof are linked; and groups in which one or not less than two of these groups are linked with one or not less than two hydrocarbon groups. The divalent hydrocarbon groups include ones exemplified in the above.

Typical examples of the alicyclic epoxy compound represented by the above formula (I) include compounds represented by the following formulae (I-1) to (I-10), and 1,2-bis(3,4-epoxycyclohexan-1-yl)ethane, 2,2-bis(3,4-epoxycyclohexan-1-yl)propane, 1,2-epoxy-1,2-bis(3,4-epoxycyclohexan-1-yl)ethane, and bis(3,4-epoxycyclohexylmethyl) ether. Here, 1 and m in the following formulae (I-5) and (I-7) are each an integer of 1 to 30. R in the following formula (I-5) is an alkylene group having 1 to 8 carbon atoms, and includes straight-chain or branched-chain alkylene groups such as a methylene group, an ethylene group, a propylene group, an isopropylene group, a butylene group, an isobutylene group, a s-butylene group, a pentylene group, a hexylene group, a heptylene group and an octylene group. Among these, preferable are straight-chain or branched-chain alkylene groups having 1 to 3 carbon atoms such as a methylene group, an ethylene group, a propylene group and an isopropylene group. n1 to n6 in the following formulae (I-9) and (I-10) each represent an integer of 1 to 30.

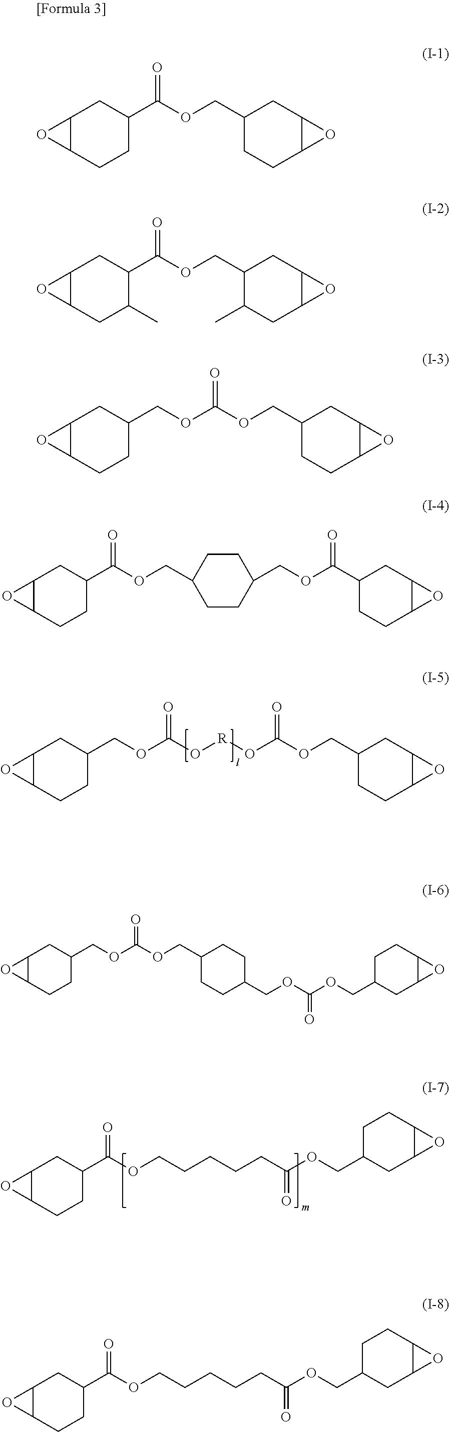

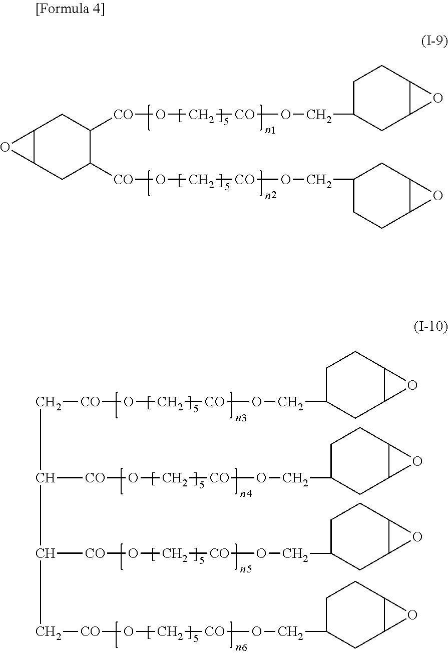

Examples of the above-mentioned (ii) compounds in which an epoxy group is bonded through a single bond directly to an aliphatic ring include a compound represented by the following formula (II).

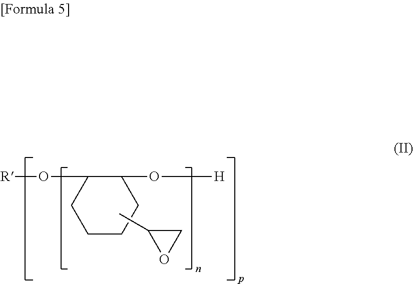

In the formula (II), R′ is, on the constitutional formula, a group (residue) formed by removing p —OHs from a p-hydric alcohol; and p and n each represent a natural number. The p-hydric alcohol [R′—(OH)ₚ] includes polyhydric alcohols (alcohols having 1 to 15 carbon atoms and the like) such as 2,2-bis(hydroxymethyl)-1-butanol. p is preferably 1 to 6, and n is preferably 1 to 30. In the case where p is not less than 2, n in the group in each ( ) (in outer parentheses) may be identical or different. Specific examples of the compound include a 1,2-epoxy-4-(2-oxiranyl)cyclohexane adduct of 2,2-bis(hydroxymethyl)-1-butanol.

As the cationically polymerizable compound (B) in the composition according to the present invention, the alicyclic epoxy compound may be used singly or may be used in a combination of two or more thereof.

Among these, as the alicyclic epoxy compound, especially preferable is 3,4-epoxycyxlohexylmethyl(3,4-epoxy)cyclohexanecarboxylate [trade name: “Celloxide 2021P”, manufactured by Daicel Corp.].

Particularly as the alicyclic epoxy compound, from the viewpoint of the heat resistance and the elastic modulus of the cured material and the fiber-reinforced composite material, preferable is concurrent use of a compound represented by the above formula (I) and a compound represented by the above formula (II). The compound represented by the above formula (I) and the compound represented by the above formula (II) each may be used singly or may be used in a combination of two or more thereof.

The functional group equivalent weight of the cationically polymerizable group of the cationically polymerizable compound (B) is not especially limited, but is preferably 50 to 300, more preferably 70 to 280, and still more preferably 80 to 260. When the functional group equivalent weight is less than 50, the toughness of a cured material and a fiber-reinforced composite material becomes insufficient in some cases. By contrast, when the functional group equivalent weight is more than 300, the heat resistance and the mechanical properties of the cured material and the fiber-reinforced composite material decrease in some cases. Here, the functional group equivalent weight of the cationically polymerizable group of the cationically polymerizable compound (B) can be calculated from the following expression.

[A functional group equivalent weight of a cationically polymerizable group]=[a molecular weight of a cationically polymerizable compound (B)]/[the number of the cationically polymerizable group of the cationically polymerizable compound (B)]

Here, in the composition according to the present invention, the cationically polymerizable compound (B) can be used singly or can be used in a combination of not less than two thereof. Further as the cationically polymerizable compound (B), there can also be used commercially available products, for example, “Celloxide 2021P” by trade name (3,4-epoxycyxlohexylmethyl(3,4-epoxy)cyclohexanecarboxylate, manufactured by Daicel Corp.), “EHPE3150” by trade name (a 1,2-epoxy-4-(2-oxiranyl)cyclohexane adduct of 2,2-bis(hydroxymethyl)-1-butanol, manufactured by Daicel Corp.), and “OXT-221” by trade name (manufactured by Toagosei Co., Ltd.), and “OXT-121” by trade name (manufactured by Toagosei Co., Ltd.).

The content (blend amount) of the cationically polymerizable compound (B) in the composition according to the present invention is not especially limited, but is, based on the total amount (100% by weight) of the composition (composition for a fiber-reinforced composite material), preferably 5 to 70% by weight, more preferably 8 to 60% by weight, and still more preferably 10 to 50% by weight. When the content is less than 5% by weight, the interfacial strength between the cured material and the reinforcing fiber (G) in the fiber-reinforced composite material decreases and the heat resistance of the cured material decreases in some cases. By contrast, when the content is more than 70% by weight, the curing speed of the composition decreases and the heat resistance of the cured material decreases in some cases. Here, in the case of concurrently using not less than two cationically polymerizable compounds (B), it is preferable that the total amount of the cationically polymerizable compounds (B) be controlled in the above range.

Particularly the proportion of the alicyclic epoxy compound to the total amount of the cationically polymerizable compound (B) in the composition according to the present invention is not especially limited, but is, from the viewpoint of the heat resistance of the cured material and the fiber-reinforced composite material, preferably not less than 50% by weight (for example, 50 to 100% by weight), and more preferably not less than 70% by weight.

In the case where as the alicyclic epoxy compound, the compound represented by the above formula (I) and the compound represented by the above formula (II) are concurrently used, the proportion (weight ratio)[the compound represented by the formula (I)/the compound represented by the formula (II)] of these compounds is not especially limited, but is, from the viewpoint of the heat resistance and the elastic modulus of the cured material and the fiber-reinforced composite material, preferably 15/85 to 90/10, and more preferably 20/80 to 80/20.

The proportion (weight ratio) [radically polymerizable compound (A)/cationically polymerizable compound (B)] of the radically polymerizable compound (A) to the cationically polymerizable compound (B) in the composition according to the present invention is not especially limited, but is preferably 30/70 to 85/15, more preferably 35/65 to 80/20, and still more preferably 40/60 to 70/30. When the proportion [a proportion to total amount (100% by weight) of the radically polymerizable compound (A) and the cationically polymerizable compound (B)] of the radically polymerizable compound (A) is less than 30% by weight, the curing speed decreases in some cases. By contrast, when the proportion of the radically polymerizable compound (A) is more than 85% by weight, the mechanical strength of the cured material and the fiber-reinforced composite material decreases and the interfacial strength between the cured material and the reinforcing fiber (G) in the fiber-reinforced composite material decreases in some cases.

### [Compound (C)]

The compound (C) in the composition according to the present invention is a compound having not less than one radically polymerizable group and not less than one cationically polymerizable group in one molecule thereof. The radically polymerizable group of the compound (C) includes the same ones as the radically polymerizable groups in the radically polymerizable compound (A). Here, in the case where the compound (C) has not less than two radically polymerizable groups, these radically polymerizable groups may be identical or different. Further the cationically polymerizable group of the compound (C) includes the same ones as the cationically polymerizable groups in the cationically polymerizable compound (B). Here, in the case where the compound (C) has not less than two cationically polymerizable groups, these cationically polymerizable groups may be identical or different.

The number of the radically polymerizable group in one molecule of the compound (C) is not especially limited as long as being not less than 1, but is, for example, preferably 1 to 5, more preferably 1 to 3, and still more preferably 1 or 2. Further the number of the cationically polymerizable group in one molecule of the compound (C) is not especially limited as long as being not less than 1, but is, for example, preferably 1 to 5, more preferably 1 to 3, and still more preferably 1 or 2.

Specific examples of the compound (C) include compounds having an epoxy group and a (meth)acryloyl group in one molecule thereof, such as 3,4-epoxycyclohexylmethyl(meth)acrylate, glycidyl(meth)acrylate, bisphenol A epoxy half (meth)acrylate (a compound obtained by reacting one epoxy group of bisphenol A diglycidyl ether with (meth)acrylic acid or its derivative), bisphenol F epoxy half (meth)acrylate and bisphenol S epoxy half (meth)acrylate; compounds having an oxetanyl group and a (meth)acryloyl group in one molecule thereof, such as 3-oxetanylmethyl(meth)acrylate, 3-methyl-3-oxetanylmethyl(meth)acrylate, 3-ethyl-3-oxetanylmethyl(meth)acrylate, 3-butyl-3-oxetanylmethyl(meth)acrylate and 3-hexyl-3-oxetanylmethyl(meth)acrylate; and compounds having a vinyl ether group and a (meth)acryloyl group in one molecule thereof, such as 2-vinyloxyethyl(meth)acrylate, 3-vinyloxypropyl(meth)acrylate, 1-methyl-2-vinyloxyethyl(meth)acrylate, 2-vinyloxypropyl(meth)acrylate, 4-vinyloxybutyl(meth)acrylate, 1-methyl-3-vinyloxypropyl(meth)acrylate, 1-vinyloxymethylpropyl(meth)acrylate, 2-methyl-3-vinyloxypropyl(meth)acrylate, 1,1-dimethyl-2-vinyloxyethyl(meth)acrylate, 3-vinyloxybutyl(meth)acrylate, 1-methyl-2-vinyloxypropyl(meth)acrylate, 2-vinyloxybutyl(meth)acrylate, 4-vinyloxycyclohexyl(meth)acrylate, 6-vinyloxyhexyl(meth)acrylate, 4-vinyloxymethylcyclohexylmethyl(meth)acrylate, 3-vinyloxymethylcyclohexylmethyl(meth)acrylate, 2-vinyloxycyclohexylmethyl(meth)acrylate, p-vinyloxymethylphenylmethyl(meth)acrylate, m-vinyloxymethylphenylmethyl(meth) acrylate, o-vinyloxymethylphenylmethyl(meth)acrylate, 2-(vinyloxyethoxy)ethyl(meth)acrylate, 2-(vinyloxyisopropoxy)ethyl(meth)acrylate, 2-(vinyloxyethoxy)propyl(meth)acrylate, 2-(vinyloxyethoxy)isopropyl(meth)acrylate, 2-(vinyloxyisopropoxy)propyl(meth)acrylate, 2-(vinyloxyisopropoxy)isopropyl(meth)acrylate, 2-(vinyloxyethoxyethoxy)ethyl(meth)acrylate, 2-(vinyloxyethoxyisopropoxy)ethyl(meth)acrylate, 2-(vinyloxyisopropoxyethoxy)ethyl(meth)acrylate, 2-(vinyloxyisopropoxyisopropoxy)ethyl(meth)acrylate, 2-(vinyloxyethoxyethoxy)propyl(meth)acrylate, 2-(vinyloxyethoxyisopropoxy)propyl(meth)acrylate, 2-(vinyloxyisopropoxyethoxy)propyl(meth)acrylate, 2-(vinyloxyisopropoxyisopropoxy)propyl(meth)acrylate, 2-(vinyloxyethoxyethoxy)isopropyl(meth)acrylate, 2-(vinyloxyethoxyisopropoxy)isopropyl(meth)acrylate, 2-(vinyloxyisopropoxyethoxy)isopropyl(meth)acrylate, 2-(vinyloxyisopropoxyisopropoxy)isopropyl(meth)acrylate, 2-(vinyloxyethoxyethoxyethoxy)ethyl(meth)acrylate, 2-(vinyloxyethoxyethoxyethoxyethoxy)ethyl(meth)acrylate, 2-(isopropenoxyethoxy)ethyl(meth)acrylate, 2-(isopropenoxyethoxyethoxy)ethyl(meth)acrylate, 2-(isopropenoxyethoxyethoxyethoxy)ethyl(meth)acrylate, 2-(isopropenoxyethoxyethoxyethoxyethoxy)ethyl(meth)acrylate, polyethylene glycol monovinyl ether(meth)acrylates and polypropylene glycol monovinyl ether(meth)acrylates.

The functional group equivalent weight of the radically polymerizable group of the compound (C) is not especially limited, but is preferably 50 to 500, more preferably 80 to 480, and still more preferably 120 to 450. When the functional group equivalent weight is less than 50, the toughness of the cured material and the fiber-reinforced composite material becomes insufficient in some cases. By contrast, when the functional group equivalent weight is more than 500, the heat resistance and the mechanical properties of the cured material and the fiber-reinforced composite material decrease in some cases. Here, the functional group equivalent weight of the radically polymerizable group of the compound (C) can be calculated by the following expression.

[A functional group equivalent weight of the radically polymerizable group]=[a molecular weight of the compound (C)]/[the number of the radically polymerizable group of the compound (C)]

The functional group equivalent weight of the cationically polymerizable group of the compound (C) is not especially limited, but is preferably 50 to 500, more preferably 80 to 480, and still more preferably 120 to 450. When the functional group equivalent weight is less than 50, the toughness of the cured material and the fiber-reinforced composite material becomes insufficient in some cases. By contrast, when the functional group equivalent weight is more than 500, the heat resistance and the mechanical properties of the cured material and the fiber-reinforced composite material decrease in some cases. Here, the functional group equivalent weight of the cationically polymerizable group of the compound (C) can be calculated by the following expression.

[A functional group equivalent weight of the cationically polymerizable group]=[a molecular weight of the compound (C)]/[the number of the cationically polymerizable group of the compound (C)]

Here, in the composition according to the present invention, the compound (C) may be used singly or may be used in a combination of two or more thereof. The compound (C) can be produced, for example, but not especially limited to, by a method in which a part of cationically polymerizable groups of a compound having not less than two cationically polymerizable groups (for example, epoxy groups) in one molecule thereof is reacted with a carboxylic acid (for example, acrylic acid or methacrylic acid) having a radically polymerizable group or its derivative, or other methods. Further as the compound (C), there can also be used commercially available products, for example, “Cyclomer M100” by trade name (manufactured by Daicel Corp.), “NK OLIGO EA1010N” by trade name (manufactured by Shin-Nakamura Chemical Co., Ltd.), and “Glycidyl Methacrylate” by trade name (manufactured by NOF Corp.).

The content (blend amount) of the compound (C) in the composition according to the present invention is not especially limited, but is, based on 100 parts by weight of the total amount of the radically polymerizable compound (A) and the cationically polymerizable compound (B), preferably 10 to 70 parts by weight, more preferably 12 to 60 parts by weight, and still more preferably 15 to 50 parts by weight. When the content is less than 10 parts by weight, the heat resistance of the cured material and the fiber-reinforced composite material decreases and the mechanical properties thereof decrease in some cases. By contrast, when the content is more than 70 parts by weight, the mechanical properties of the cured material and the fiber-reinforced composite material decrease in some cases. Here, in the case where not less than two compounds (C) are concurrently used, it is preferable that the total amount of the compounds (C) be controlled in the above range.

### [Radical Polymerization Initiator (D)]

The radical polymerization initiator (D) in the composition according to the present invention is a compound to initiate the polymerization reaction of compounds (the radically polymerizable compound (A), the compound (C)) having radically polymerizable groups out of curable compounds (compounds having polymerizable groups, particularly compounds having either radically polymerizable groups or cationically polymerizable groups, or both) in the composition. The radical polymerization initiator (D) is not especially limited, and a known or common radical polymerization initiator can be used. Examples thereof include thermal radical polymerization initiators, and photoradical polymerization initiators.

Examples of the thermal radical polymerization initiator include organic peroxides. As the organic peroxides, there can be used, for example, dialkyl peroxides, acyl peroxides, hydroperoxides, ketone peroxides and peroxyesters. Specific examples of the organic peroxides include, benzoyl peroxide, t-butyl peroxy-2-ethylhexanoate, 2,5-dimethyl-2,5-di(2-ethylhexanoyl)peroxyhexane, t-butyl peroxybenzoate, t-butyl peroxide, cumene hydroperoxide, dicumyl peroxide, di-t-butyl peroxide, 2,5-dimethyl-2,5-dibutylperoxyhexane, 2,4-dichlorobenzoyl peroxide, di-t-butylperoxydi-isopropylbenzene, 1,1-bis(t-butylperoxy)-3,3,5-trimethylcyclohexane, methyl ethyl ketone peroxide, and 1,1,3,3-tetramethylbutyl peroxy-2-ethylhexanoate. There can also be used commercially available products such as “Perocta O” by trade name (manufactured by NOF Corp.), “Perbutyl O” by trade name (manufactured by NOF Corp.), “Perhexa C” by trade name (manufactured by NOF Corp.), and “Perhexa CS” by trade name (manufactured by NOF Corp.).

As the thermal radical polymerization initiator, other than the above organic peroxides, azo compounds can also be used. Examples of the azo compounds include 2,2′-azobisisobutyronitrile (AIBN), 2,2′-azobis(2-methylbutyronitrile), 2,2′-azobis(4-methoxy-2,4-dimethylvaleronitrile), 2,2′-azobis(2,4-dimethylvaleronitrile), 2,2′-azobis(2-hydroxymethylpropionitrile), 1,1′-azobiscyclohexane-1-carbonitrile, 4,4′-azobis(4-cyanovaleric acid), 2-(carbamoylazo)isobutyronitrile, 2-phenylazo-4-methoxy-2,4-dimethylvaleronitrile, 2,2′-azobis(2-methylpropane), 2,2′-azobis(2,4,4-trimethylpentane), and dimethyl 2,2′-azobisisobutyrate. As the thermal radical polymerization initiator, additionally, there may also be used or concurrently used hydrogen peroxide, and inorganic peroxides such as persulfate salts (for example, potassium persulfate and ammonium persulfate).

Further with the thermal radical polymerization initiator, there can be concurrently used metal salts of metals such as cobalt, manganese, lead, zinc and vanadium with naphthenic acid and octenoic acid, such as cobalt naphthenate, manganese naphthenate, zinc naphthenate and cobalt octenoate. Similarly, tertiary amines such as dimethylaniline can also be used.

Examples of the photoradical polymerization initiator include benzophenone, acetophenone benzyl, benzyl dimethyl ketone, benzoin, benzoin methyl ether, benzoin ethyl ether, benzoin isopropyl ether, dimethoxyacetophenone, dimethoxyphenylacetophenone, diethoxyacetophenone, diphenyl disulfite, methyl orthobenzoylbenzoate, ethyl 4-dimethylaminobenzoate (manufactured by Nippon Kayaku Co., Ltd., trade name: “kayacure EPA”, or the like), 2,4-diethylthioxanthone (manufactured by Nippon Kayaku Co., Ltd., trade name: “Kayacure DETX”, or the like), 2-methyl-1-[4-(methyl)phenyl]-2-morpholinopropanone-1 (manufactured by Ciba-Geigy Corp., trade name: “Irgacure 907” or the like), 2-amino-2-benzoyl-1-phenylalkane compounds such as 2-dimethylamino-2-(4-morpholino)benzoyl-1-phenylpropane, tetra(t-butylperoxycarbonyl)benzophenone, benzil, 2-hydroxy-2-methyl-1-phenyl-propan-1-one, aminobenzene derivatives such as 4,4-bisdiethylaminobenzophenone, imidazole compounds such as 2,2′-bis(2-chlorophenyl)-4,5,4′,5′-tetraphenyl-1,2′-biimidazole (manufactured by Hodagaya Chemical Co., Ltd., trade name: “B-CIM” or the like), halomethylated triazine compounds such as 2,6-bis(trichloromethyl)-4-(4-methoxynaphthalen-1-yl)-1,3,5-triazine, and halomethyloxadiazole compounds such as 2-trichloromethyl-5-(2-benzofuran-2-yl-ethenyl)-1,3,4-oxadiazole.

Here, in the composition according to the present invention, the radical polymerization initiator (D) can be used singly or in a combination of not less than two thereof.

The content (blend amount) of the radical polymerization initiator (D) in the composition according to the present invention is not especially limited, but is, based on 100 parts by weight of the total amount of the radically polymerizable compound (A), the cationically polymerizable compound (B), and the compound (C) preferably 0.01 to 10 parts by weight, more preferably 0.05 to 8 parts by weight, and still more preferably 0.1 to 5 parts by weight. When the content is less than 0.01 part by weight, the progress of the curing speed becomes insufficient in some cases. By contrast, when the content is more than 10 parts by weight, the heat resistance of a cured material and a fiber-reinforced composite material, though depending on applications, becomes insufficient in some cases. Here, in the case where not less than two radical polymerization initiators (D) are concurrently used, it is preferable that the total amount of the radical polymerization initiators (D) be controlled in the above range.

### [Acid Generator (E)]

The acid generator (E) in the composition according to the present invention is a compound to initiate a polymerization reaction (cationic polymerization reaction) of a compound (the cationically polymerizable compound (B), the compound (C)) having a cationically polymerizable group among curable compounds in the composition. As the acid generator (E), a known or common acid generator can be used, and the acid generator (E) is not especially limited. Examples thereof include thermoacid generators and photoacid generators.

The acid generator (E) includes compounds to generate an acid by heating or irradiation of active energy rays, and specific examples thereof include sulfonium salts such as triallylsulfonium hexafluorophosphate and triarylsulfonium hexafluoroantimonate; iodonium salts such as diaryliodonium hexafluorophosphate, diphenyliodonium hexafluoroantimonate, bis(dodecylphenyl)iodonium tetrakis(pentafluorophenyl)borate and iodonium[4-(4-methylphenyl-2-methylpropyl)phenyl]hexafluorophosphate; phosphonium salts such as tetrafluorophosphonium hexafluorophosphate; pyridinium salts; diazonium salts; selenium salts; ammonium salts; ether complexes of boron trifluoride such as a boron trifluoride-ethyl ether complex.

As the thermoacid generator, there can also be used commercially available products, for example, by trade names, “Sanaid SI-45”, “Sanaid SI-47”, “Sanaid SI-60”, “Sanaid SI-60L”, “Sanaid SI-80”, “Sanaid SI-80L”, “Sanaid SI-100”, “Sanaid SI-100L”, “Sanaid SI-110L”, “Sanaid SI-145”, “Sanaid SI-150”, “Sanaid SI-160”, “Sanaid SI-110L” and “Sanaid SI-180L” (the foregoing, manufactured by Sanshin Chemical Industry Co., Ltd.); by trade names, “CI-2921”, “CI-2920”, “CI-2946”, “CI-3128”, “CI-2624”, “CI-2639” and “CI-2064” (the foregoing, manufactured by Nippon Soda Co., Ltd.); by trade names, “PP-33”, “CP-66” and “CP-77” (the foregoing, manufactured by ADEKA Corp.); and, by trade names, “FC-509” and “FC-520” (the foregoing, manufactured by 3M Co.) Further the thermoacid generator may be a compound of a chelate compound, of a metal such as aluminum or titanium with acetoacetic acid or a diketone, with a silanol such as triphenyl silanol, or a compound of a chelate compound, of a metal such as aluminum or titanium with acetoacetic acid or a diketone, with a phenol such as bisphenol S.

As the photoacid generator, there can also be used commercially available products, for example, by trade names, “Cyracure UVI-6970”, “Cyracure UVI-6974”, “Cyracure UVI-6990” and “Cyracure UVI-950” (the foregoing, manufactured by Union Carbide Corp.); by trade names, “Irgacure 250”, “Irgacure 261”, “Irgacure 264” and “CG-24-61” (the forgoing, manufactured by BASF AG); by trade names, “SP-150”, “SP-151”, “SP-170” and “Optpmer SP-171” (the foregoing, manufactured by ADEKA Corp.); by trade name, “DAICATII” (manufactured by Daicel Corp.); by trade names, “UVAC1590” and “UVAC1591” (the foregoing, manufactured by Daicel-Cytec Co., Ltd.); by trade names, “CI-2064”, “CI-2639”, “CI-2624”, “CI-2481”, “CI-2734”, “CI-2855”, “CI-2823”, “CI-2758” and “CIT-1682” (the foregoing, manufactured by Nippon Soda Co., Ltd.); by trade name, “PI-2074” (manufactured by Rhodia Chemie N.V., pentafluorophenylborate toluylcumyl iodonium salt); by trade name, “FFC509” (manufactured by 3M Co.); by trade names, “BBI-102”, “BBI-101”, “BBI-103”, “MPI-103”, “TPS-103”, “MDS-103”, “DTS-103”, “NAT-103” and “NDS-103” (the foregoing, manufactured by Midori Kagaku Co., Ltd.); by trade names, “CD-1010”, “CD-1011” and “CD-1012” (the foregoing, manufactured by Sartomer Corp. (US)); and by trade names, “CPI-100P” and “CPI-101A” (the foregoing, manufactured by San-Apro Ltd.).

Here, in the composition according to the present invention, the acid generator (E) can be used singly or in a combination of not less than two thereof.

The content (blend amount) of the acid generator (E) in the composition according to the present invention is not especially limited, but is, based on 100 parts by weight of the total amount of the radically polymerizable compound (A), the cationically polymerizable compound (B), and the compound (C) preferably 0.1 to 20 parts by weight, more preferably 0.2 to 15 parts by weight, and still more preferably 0.3 to 5 parts by weight. When the content is less than 0.1 part by weight, the progress of the curing reaction becomes insufficient in some cases. By contrast, when the content is more than 20 parts by weight, the heat resistance of a cured material and a fiber-reinforced composite material, though depending on applications, becomes insufficient in some cases. Here, in the case where not less than two acid generators (E) are concurrently used, it is preferable that the total amount of the acid generators (E) be controlled in the above range.

### [Release Agent (F)]

As the release agent (F) in the composition according to the present invention, a known or common release agent can be used, and the release agent (F) is not especially limited. Examples thereof include silicone compounds, fluorine-containing compounds (vinylidene fluoride resins, fluorinated ethylene-propylene resins, fluorinated oligomers and the like), synthetic waxes such as polyethylene wax, natural waxes such as carnauba wax, fatty acids and their derivatives, paraffins, Teflon® powder, and (poly)oxyalkylene alkylphosphoric acid compounds.

Among these, from the viewpoint of exhibiting especially excellent releasability for the fiber-reinforced composite material in the pultrusion method, preferable as the release agent (F) are fatty acids (for example, higher fatty acids having 10 to 30 carbon atoms) and their derivatives, and examples thereof include fatty acids such as stearic acid; metal salts of fatty acids (for example, alkaline metal salts such as a sodium salt, alkaline earth metal slats such as a calcium salt, and other metal salts such as a zinc salt); esters of fatty acids with polyhydric alcohols (for example, glycerol); and fatty acid amides, and more specifically include zinc stearate, monoglyceride stearate, stearic acid, calcium stearate, sodium stearate, stearic acid amide, and ethylenebisstearic acid amide. Among these, preferable are particularly metal stearate compounds (compounds containing a structural unit originated from stearic acid and a metal; for example, a metal salt of stearic acid). Although the reason of exhibiting especially excellent releasability for the fiber-reinforced composite material in the pultrusion method is not clear, it is presumably because these release agents are liable to be present in heterogeneous state with other components in the composition according to the present invention and tend to segregate on the surface.

Here, the release agent (F) may be used singly or may be used in a combination of two or more thereof in the composition according to the present invention.

The content (blend amount) of the release agent (F) in the composition according to the present invention is not especially limited, but is, based on 100 parts by weight of the total amount (total amount of the components (A) to (E)) of the radically polymerizable compound (A), the cationically polymerizable compound (B), the compound (C), the radical polymerization initiator (D) and the acid generator (E), preferably 1 to 8 parts by weight, more preferably 1.5 to 7 parts by weight, and still more preferably 2 to 6 parts by weight. When the content is less than 1 part by weight, sufficient releasability cannot be attained in the case where curing is carried out at a high speed in the pultrusion method, and the pulling stress increases during the molding, making continuous molding difficult in some cases. By contrast, when the content is more than 8 parts by weight, the curability of the cured material and the fiber-reinforced composite material become insufficient to decrease the heat resistance and the mechanical properties thereof in some applications. Here, in the case where not less than two release agents (F) are concurrently used, it is preferable that the total amount of the release agents (F) be controlled in the above range.

To the composition according to the present invention, as required, other additives may further be added as long as not impairing the advantage of the present invention. Examples of the other additives include fillers such as talc, curable expandable monomers, photosensitizers (anthracene sensitizers and the like), resins, adhesion improvers, reinforcing agents, softening agents, plasticizers, viscosity regulators, solvents, inorganic or organic particles (nano-scale particles and the like), and various types of known common additives of fluorosilane and the like.

The composition according to the present invention can be produced by blending and homogeneously mixing the above-mentioned constituting components (the radically polymerizable compound (A), the cationically polymerizable compound (B), the compound (C), the radical polymerization initiator (D), the acid generator (E), the release agent (F), the additives, and the like) in predetermined proportions. The mixing of the constituting components can be carried out by using a known or common stirring apparatus (mixing apparatus), and is not especially limited, and it can be carried out, for example, by using a stirring apparatus such as a rotation-revolution type stirring and defoaming apparatus, a homogenizer, a planetary mixer, a three-roll mill or a bead mill.

The viscosity at 25° C. of the composition according to the present invention is, but not limited to, preferably 50 to 30,000 mPa·s, more preferably 100 to 5,000 mPa·s, and still more preferably 150 to 2,000 mPa·s from the viewpoint of the handleability and the workability. Here, the viscosity at 25° C. of the composition can be measured, for example, by a viscometer (trade name: “HAAKE Rheo Stress 6000”, manufactured by Thermo SCIENTIFIC Co., Ltd.)(for example, rotor: 1°×R10, rotation frequency: 10 rpm, measurement temperature: 25° C.)

Particularly from the viewpoint of the work stability, it is preferable for the composition according to the present invention that the viscosity right after the preparation (a viscosity measured within 1 hour of the preparation; sometimes referred to as “initial viscosity”) and a viscosity after the composition be left at 25° C. for 72 hours after the preparation are both controlled in the above range. The viscosity right after the preparation is controlled in the above range, but, for example, in the case where the viscosity after the composition is left at 25° C. for 72 hours exceeds two times the initial viscosity, there is a possibility that curing progresses during the storage, and the work stability remarkably decreases and the quality of a cured material (particularly a fiber-reinforced composite material) decreases in some cases.

By polymerizing (more specifically, radically polymerizing and cationically polymerizing) the radically polymerizable compound (A), the cationically polymerizable compound (B) and the compound (C) in the composition according to the present invention, the composition according to the present invention can be cured to obtain a cured material (cured resin material). Means of initiating the polymerization reaction can suitably be selected according to the kinds and the contents of the radical polymerization initiator (D) and the acid generator (E), and is not especially limited, and it includes, for example, heating, and irradiation of active energy rays (for example, ultraviolet rays, infrared rays, visible light rays, and electron beams). Particularly, it is preferable that the polymerization reaction use a thermal radical polymerization initiator as the radical polymerization initiator (D) and a thermal acid generator as the acid generator (E), and be initiated by heating.

The conditions for curing the composition according to the present invention can suitably be selected depending on the kinds and the contents of the radical polymerization initiator (D) and the acid generator (E), and is not especially limited; but for example, as the conditions for the case of curing by heating, the heating temperature of 120 to 230° C. (more preferably 130 to 220° C., still more preferably 140 to 210° C.) and the heating time of 0.1 to 10 minutes are preferable (more preferably 0.5 to 5 minutes, still more preferably 1 to 3 minutes). When the heating temperature is too low or when the heating time is too short, the curing becomes insufficient and the heat resistance and the mechanical properties of a cured material decreases in some cases. By contrast, when the heating temperature is too high or when the heating time is too long, the decomposition and the deterioration of the components in the composition are caused in some cases.

The composition according to the present invention may be cured by subjecting the composition to a heat treatment under the above-mentioned condition (for example, a heat treatment to improve the degree of curing of a cured material obtained by curing the composition to not less than 80%; referred to as “primary curing”), and thereafter subjecting the primarily cured composition to a heat treatment (for example, a heat treatment to improve the degree of curing of the cured material obtained by curing the composition to not less than 90%; sometimes referred to as “post-baking” or “secondary curing”) at a higher temperature than the condition of the primary curing. The condition of the post-baking (secondary curing) is not especially limited, but can suitably be selected, for example, from conditions of at 230 to 270° C. for 0.1 to 30 min. Here, the post-baking (secondary curing) does not necessarily need to be carried out depending on applications.

Here, the degree of curing of the cured material can be calculated, for example, by using an exothermic amount and the like in curing as measured by differential scanning calorimetry (DSC)(the degree of curing thus measured is sometimes referred to as “degree of curing measured by differential scanning calorimetry”). Specifically, the degree of curing can be determined by carrying out DSC, for example, on the composition and the cured material (the cured material obtained by the heat treatment of the composition) by using the following apparatus and under the following condition, and calculating the degree of curing by the following calculation expression from the measured exothermic amount.

### <Measurement Apparatus and Measurement Condition>

Measurement apparatus: a differential scanning calorimeter (trade name: “Q-2000”, manufactured by TA INSTRUMENTS Co., Ltd.)

First heating condition: temperature-rise rate: +20° C./min, temperature range: 0° C. to 300° C.

Second heating condition: temperature-rise rate: +20° C./min, temperature range: 0° C. to 300° C.

Measurement atmosphere: nitrogen

### <Calculation Method (Calculation Expression) of the Degree of Curing>

[A degree of curing of the cured material (%)]=[1−{[an exothermic amount in the first heating of the cured material]+[an exothermic amount in the second heating of the cured material]}/{[an exothermic amount in the first heating of the composition(the composition for a fiber-reinforced composite material)]+[an exothermic amount in the second heating of the composition(the composition for a fiber-reinforced composite material]}]×100

The condition in the case where the composition according to the present invention is cured by irradiation of active energy rays is not especially limited, and there can be employed, for example, the condition where ultraviolet rays of not less than 1,000 mJ/cm² are irradiated by a mercury lamp or the like. Here, in the case where the composition according to the present invention is cured, heating and irradiation of active energy rays may be combined.

Particularly, the composition according to the present invention is very useful in the point of being capable of being cured (for example, the degree of curing of the cured material can be raised to not less than 80%) in a shorter time, since having a high curing speed. Thereby, the productivity of the fiber-reinforced composite material can be improved remarkably.

In the composition according to the present invention, the degree of curing [degree of curing measured by the above-mentioned differential scanning calorimetry] of a cured material obtained by curing the composition by a heat treatment at 220° C. for 2 min is preferably not less than 80%, and more preferably not less than 85% (for example, 85 to 100%). Further in the composition according to the present invention, the degree of curing of a cured material obtained by curing the composition by a heat treatment at 180° C. for 2 min is preferably not less than 80% (more preferably not less than 85%); and more preferably, the degree of curing of a cured material obtained by curing the composition by a heat treatment at 140° C. for 2 min is not less than 80% (more preferably not less than 85%).

The glass transition temperature (Tg) of a cured material obtained by curing the composition according to the present invention is not especially limited, but is preferably not less than 100° C. (for example, 100 to 300° C.), more preferably not less than 140° C. (for example, 140 to 300° C.), still more preferably not less than 150° C., and especially preferably not less than 180° C. When the glass transition temperature is less than 100° C., the heat resistance of a fiber-reinforced composite material, though depending on applications, becomes insufficient in some cases. Here, the glass transition temperature can be determined by a measurement according to JIS K7244-4, in more detail, as a peak top temperature of tan δ (loss tangent) measured in a dynamic viscoelasticity measurement (which is carried out under the conditions of, for example, the temperature-rise rate: 5° C./rain, the measurement temperatures: 25 to 350° C., and deformation mode: tensile mode).

The elastic modulus (storage elastic modulus, sometimes referred to also as “elastic modulus E′”) at 30° C. of the cured material obtained by curing the composition according to the present invention is not especially limited, but is preferably not less than 1×10⁸ Pa (for example, 1×10⁸ to 1×10¹² Pa), more preferably not less than 5×10⁸ Pa, and still more preferably not less than 6×10⁸ Pa. When the elastic modulus at 30° C. is less than 1×10⁸ Pa, the hardness becomes insufficient for some applications.

The elastic modulus at 250° C. of the cured material obtained by curing the composition according to the present invention is not especially limited, but is preferably not less than 1×10⁸ Pa (for example, 1×10⁸ to 1×10¹² Pa), more preferably not less than 3×10⁸ Pa, and still more preferably not less than 5×10⁸ Pa. When the elastic modulus at 250° C. is less than 1×10⁸ Pa, the heat resistance of the fiber-reinforced composite material becomes insufficient for some applications.

The reduction rate (referred to as “E′ reduction rate) of the elastic modulus E′ of the cured material obtained by curing the composition according to the present invention as calculated by the following expression is not especially limited, but is preferably not more than 50%, more preferably not more than 40%, still more preferably not more than 30%, and especially preferably not more than 20%. Although it is most preferable that the lower limit of the reduction rate of the E′ be 0%, for example, 3% may be satisfactory. Here, the E′ reduction rate is calculated by the following expression.

A reduction rate of the elastic modulus E′ (%)=100(a−b)/a

In the above expression, a represents an elastic modulus (Pa) at a temperature (° C.) of (the glass transition temperature of the cured material)−10° C.) of the cured material; and b represents an elastic modulus (Pa) at a temperature (° C.) of (the glass transition temperature of the cured material)+10° C.) of the cured material. That is, the reduction rate of the elastic modulus E′ being low indicates that a change (reduction) between the elastic modulus of the cured material below the glass transition temperature and that above the glass transition temperature is small, that is, means that the heat resistance is excellent. Here, the elastic modulus of the cured material can be measured, for example, by the same dynamic viscoelasticity measurement as that for the glass transition temperature of the cured material.

### [Prepreg, Fiber-Reinforced Composite Material]

By impregnating the composition according to the present invention into a reinforcing fiber (G), a prepreg (referred to as “prepreg according to the present invention” in some cases) is formed. That is, the prepreg according to the present invention contains the composition according to the present invention and the reinforcing fiber (G) as essential components.

The reinforcing fiber (G) is not especially limited, but examples thereof include carbon fibers, glass fibers, aramid fibers, boron fibers, graphite fibers, silicon carbide fibers, high-strength polyethylene fibers, tungsten carbide fibers and polyparaphenylene benzoxazole fibers (PBO fibers). Examples of the carbon fiber include polyacrylonitrile (PAN)-based carbon fibers, pitch-based carbon fibers and vapor grown carbon fibers. Among these, from the viewpoint of the mechanical properties, carbon fibers, glass fibers and aramid fibers are preferable. Here, in the prepreg according to the present invention, the reinforcing fiber (G) can be used singly or can be used in a combination of not less than two thereof.

The form of the reinforcing fiber (G) in the prepreg according to the present invention is not especially limited, and examples thereof include forms of filaments (long fibers), forms of tows, forms of unidirectional materials in which tows are unidirectionally arrayed, forms of woven cloths and forms of nonwoven fabrics. Examples of the woven cloths of the reinforcing fiber (G) include plain woven ones, twill woven ones, satin woven ones, and stitching sheets obtained by stitching, so as not to be loosened, sheets in which fiber bundles represented by non-crimp fabrics are unidirectionally aligned or sheets in which sheets are laminated with angles thereof being varied.

The content of the reinforcing fibers (G) (referred to as “fiber mass content rate (Wf)” in some cases) in the prepreg according to the present invention is not especially limited, but is preferably 50 to 90% by weight, more preferably 60 to 85% by weight, and still more preferably 65 to 80% by weight. When the content is less than 50% by weight, the mechanical strength and the heat resistance of the fiber-reinforced composite material, though depending on applications, become insufficient in some cases. By contrast, when the content is more than 90% by weight, the mechanical strength (for example, toughness) of the fiber-reinforced composite material, though depending on applications, become insufficient in some cases.

The prepreg according to the present invention may be one obtained by impregnating the composition according to the present invention into the reinforcing fiber (G), and thereafter subjecting the resultant to heating, active energy-ray irradiation, or the like to thereby cure a part of curable compounds in the composition (that is, semi-cure).

A method for impregnating the composition according to the present invention into the reinforcing fiber (G) is not especially limited, and the impregnation can be carried out by an impregnation method in known or common prepreg production methods.

By curing the prepreg according to the present invention, the fiber-reinforced composite material can be obtained. The fiber-reinforced composite material, since a cured material of the composition according to the present invention is reinforced with the reinforcing fiber (G), has very excellent mechanical strength and heat resistance. The condition for curing the prepreg according to the present invention is not especially limited, but for example, the same condition as the above condition for curing the composition according to the present invention can be employed. Particularly since the prepreg according to the present invention is capable of being cured (for example, the degree of curing of the cured material can be raised to not less than 80%) in a shorter time, the productivity of the fiber-reinforced composite material is improved remarkably.

Production methods of the prepreg and the fiber-reinforced composite material according to the present invention can employ, for example, a pultrusion method. Specifically, the fiber-reinforced composite material can be obtained as follows: the reinforcing fiber (G) is continuously passed through a resin bath (a resin bath filled with the composition according to the present invention) to thereby impregnate the composition according to the present invention into the reinforcing fiber (G); then, as required, the resultant is passed through a squeeze die to thereby form a prepreg (the prepreg according to the present invention); thereafter, for example, the resultant is cured while being passed through a heated mold and subjected to continuous pultrusion by a pulling machine, to be thereby obtain the fiber-reinforced composite material. The obtained fiber-reinforced composite material may further be subjected to a heat treatment (post-baking) using an oven or the like. Particularly since the prepreg according to the present invention has a high curing speed, the prepreg can be advantageously used for the production of the fiber-reinforced composite material by the above-mentioned pultrusion method, which requires short-time curing. Particularly since the composition (and the prepreg) according to the present invention has the above constitution, the composition (and the prepreg) is useful in the point that the obtained fiber-reinforced composite material is excellent in the releasability from a mold thereby not to increase the pulling stress during molding, making the continuous molding possible even when it is cured at high speeds in the pultrusion method.

The prepreg and the fiber-reinforced composite material according to the present invention can be produced not only by a method limited to the above-mentioned molding method (pultrusion method) but also by a known or common method for producing prepregs and fiber-reinforced composite materials, for example, methods of hand lay-up, prepreg, RTM, pultrusion, filament winding, spray-up and the like.

The glass transition temperature (Tg) of the fiber-reinforced composite material according to the present invention is not especially limited, but is preferably not less than 100° C. (for example, 100 to 300° C.), more preferably not less than 140° C. (for example, 140 to 300° C.), still more preferably not less than 150° C., and especially preferably not less than 180° C. When the glass transition temperature is less than 100° C., the heat resistance becomes insufficient for some applications. Here, the glass transition temperature can be measured by the same method as that for the cured material.

The elastic modulus at 30° C. of the fiber-reinforced composite material according to the present invention is not especially limited, but is preferably not less than 1×10⁸ Pa (for example, 1×10⁸ to 1×10¹² Pa), more preferably not less than 5×10⁸ Pa, and still more preferably not less than 6×10⁸ Pa. When the elastic modulus at 30° C. is less than 1×10⁸ Pa, the hardness becomes insufficient for some applications.

The elastic modulus at 250° C. of the fiber-reinforced composite material according to the present invention is not especially limited, but is preferably not less than 1×10⁸ Pa (for example, 1×10⁸ to 1×10¹² Pa), more preferably not less than 3×10⁸ Pa, and still more preferably not less than 5×10⁸ Pa. When the elastic modulus at 250° C. is less than 1×10⁸ Pa, the heat resistance becomes insufficient for some applications.

The reduction rate (E′ reduction rate) of the elastic modulus E′ of the fiber-reinforced composite material according to the present invention as calculated by the above expression is not especially limited, but is preferably not more than 50%, more preferably not more than 40%, still more preferably not more than 30%, and especially preferably not more than 20%. Although it is most preferable that the lower limit of the reduction rate of the E′ be 0%, for example, 3% may be satisfactory. Here, the reduction rate of the E′ of the fiber-reinforced composite material according to the present invention can be calculated by the same method as that for the reduction rate of the elastic modulus E′ of the cured material.

The fiber-reinforced composite material according to the present invention can be used as a material for various types of constructions, and is not especially limited, but it can preferably be used, for example, as a material for constructions such as: fuselages, main wings, tail assemblies, mobile wings, fairings, cowls, doors and the like of aircrafts; motor cases, main wings and the like of spacecrafts; body structures of artificial satellites; automobile parts such as chassis of automobiles; body structures of railroad vehicles; body structures of bicycles; body structures of marine vessels; blades of wind power generators; pressure vessels; fishing rods; tennis rackets; golf shafts; robot arms; and cables (for example, core materials of cables).

The fiber-reinforced composite material according to the present invention can preferably be used, for example, as a core material of electric wire to be used as aerial wire. Since the composite material according to the present invention is high in strength, small in weight and low in linear expansion coefficient, use of electric wire having a core material formed from the fiber-reinforced composite material according to the present invention enables the reduction of the number of steel towers and the improvement of the transmission capacity to be achieved. Further, since having a high heat resistance, the fiber-reinforced composite material according to the present invention can preferably be used as a core material for electric wire (high-tension wire) of a high voltage, which is liable to generate heat. The core material can be formed by a known method, for example, a pultrusion method or a stranded wire molding method.

### EXAMPLES

Hereinafter, the present invention will be described in detail by way of Examples, but the present invention is not limited to these Examples.

### Examples 1 to 4, and Comparative Example 1

### Productions of Compositions for Fiber-Reinforced Composite Materials and Cured Materials

Each component was blended according to the blend compositions (unit: parts by weight) indicated in Table 1, and stirred and mixed by a stirring blade in a separable flask to thereby obtain compositions for fiber-reinforced composite materials.

### [Production of Prepregs and Fiber-Reinforced Composite Materials]

Prepregs and fiber-reinforced composite materials were produced by a continuous pultrusion method. Specifically, stringy continuous carbon fibers are passed in a resin bath filled with the composition (composition for a fiber-reinforced composite material) obtained in the above to thereby impregnate the composition into the carbon fibers; then, the excessive composition is squeezed; and the resultant is defoamed to thereby form a prepreg.

Thereafter, the prepreg is introduced in a mold of 4 mmφ, subjected to heat curing (primary curing) at two-stage temperatures of 150° C. and 220° C. for a total time of 2 min, and then, pulled by a pulling apparatus, and the resultant is further subjected to a heat treatment under the post-baking condition at 240° C. for 8 min to thereby produce a fiber-reinforced composite material. Here, in the case of compositions for fiber-reinforced composite materials of Examples, any of the degrees of curing after the primary curing of the compositions was not less than 80%.

### [Evaluations]

For the composition for the fiber-reinforced composite materials and fiber-reinforced composite materials obtained in Examples and Comparative Examples, the following evaluations were carried out.

### (1) Continuous Pultrudability

In production of the fiber-reinforced composite material by the above-mentioned pultrusion method, the case where the fiber-reinforced composite material could be continuously molded at a pulling speed of not less than 60 cm/min was evaluated as ⊙ (being excellent in the continuous pultrudability); the case where the fiber-reinforced composite material could be continuously molded at a pulling speed of not less than 30 cm/min and less than 60 cm/min was evaluated as ◯ (being good in the continuous pultrudability); and the case where when the pultrusion was carried out at a pulling speed of 30 cm/min, the pulling stress increased to thereby result in suspending of the molding on the way was evaluated as x (being poor in the continuous pultrudability).

### (2) Glass Transition Temperature and Elastic Modulus

The fiber-reinforced composite materials obtained in Examples and Comparative Example were each cut out into 0.5 mm in thickness, 3 mm in width and 20 mm in length, and were used as samples.

Dynamic viscoelasticity analyses (DMA) of the samples obtained in the above were carried out under the following condition.

### <Measurement Apparatus and Measurement Condition>

Measurement apparatus: a solid elasticity analyzer (“RSAIII”, manufactured by TA Instruments)

Atmosphere: nitrogen

Temperature range: 25 to 350° C.

Temperature-rise rate: 5° C./min

Deformation mode: three-point bending mode

A peak top temperature of tan δ (loss tangent) measured in the above dynamic viscoelasticity analysis was determined as a glass transition temperature (Tg) of the fiber-reinforced composite materials. The results are shown in the column of “Tg” of Table 1.

Further the elastic moduli (E′(30° C.)) at 30° C. and the elastic moduli (E′(250° C.)) at 250° C. measured by the above dynamic elasticity measurement are shown in columns of “E′(30° C.)” and “E′(250° C.)” of Table 1, respectively.

Further from the results of the elastic moduli E′ measured by the dynamic elasticity measurement, the elastic moduli E′ of the fiber-reinforced composite materials at temperatures (° C.) of (glass transition temperature thereof−10° C.) are shown in the column of “E′(Tg-10° C.)” of Table 1; and the elastic moduli E′ of the fiber-reinforced composite materials at temperatures (° C.) of (glass transition temperatures thereof+10° C.) are shown in the column of “E′(Tg+10° C.)” of Table 1. Then, from these values, the reduction rates of the elastic moduli E′ were calculated by the following expression, and are shown in the column of “E′ reduction rate” of Table 1.

A reduction rate of the elastic modulus E′ (%)=100×(a−b)/a

wherein a represents an elastic modulus (Pa) of the fiber-reinforced composite material at a temperature (° C.) of (the glass transition temperature thereof−10° C.); and b represents an elastic modulus (Pa) of the fiber-reinforced composite material at a temperature (° C.) of (the glass transition temperature thereof+10° C.)

### (3) Linear Expansion Coefficient

The fiber-reinforced composite materials obtained in Examples and Comparative Example were cut out along the fiber direction into 15 mm (fiber direction) in height, 2.5 mm in width and 2.5 mm in length, and were used as samples.

The linear expansion coefficient measurement (TMA) of the samples obtained in the above was carried out under the following condition, and the linear expansion coefficients in the fiber direction (in the longitudinal direction of the fibers) and in the direction perpendicular to the fibers (in the orthogonal direction to the fiber direction) were measured. The results are shown in “linear expansion coefficient (fiber direction)” and “linear expansion coefficient (perpendicular-to fiber direction)” of Table 1.

### <Measurement Apparatus and Measurement Condition>

Measurement apparatus: a thermomechanical analyzer (EXSTAR TMA/SS7100, manufactured by SII Nano Technology Inc.)

Atmosphere: nitrogen

Temperature range: 30 to 200° C.

Temperature-rise rate: 5° C./min

Load: 30 mN

Measurement mode: compression

### (4) Viscosity

The viscosities at 25° C. of the compositions for fiber-reinforced composite materials obtained in Examples and Comparative Examples were measured right after the preparations (within 1 hour of the preparation) of the compositions. The results are shown in the column of “Viscosity of Composition for fiber-reinforced composite materials” of Table 1.

Further, after the compositions for fiber-reinforced composite materials were stored under the environment of 25° C. for 72 hours after the preparations thereof, the viscosities were measured. The results are shown in the column of “Viscosity after Storage at 25° C. for 72 hours of Composition for fiber-reinforced composite materials” of Table 1.

Here, the measurement apparatus and the measurement condition of the viscosity were as follows.

### <Measurement Apparatus and Measurement Condition>

Measurement apparatus: a viscometer (trade name: “HAAKE Rheo Stress 6000”, manufactured by Thermo SCIENTIFIC Co., Ltd.)

Rotor: 1°×R10

Rotation frequency: 10 rpm

Measurement temperature: 25° C.

TABLE 1

| | | | | | | | | Comparative |
|---|---|---|---|---|---|---|---|---|
| | | | | Example 1 | Example 2 | Example 3 | Example 4 | Example 1 |
| Prepreg | Composition for a | Radically Polymerizable | IRR214-K | 24.2 | 24.7 | 24.7 | 24.2 | 24.7 |
| | Fiber-Reinforced | Compound (A) | DPHA | 16.1 | 16.5 | 16.5 | 16.1 | 16.5 |
| | Composite Material | Cationically Polymerizable | Celloxide 2021P | 20.2 | 20.6 | 20.6 | 20.2 | 20.6 |
| | | Compound (B) | EHPE 3150 | 20.2 | 20.6 | 20.6 | 20.2 | 20.6 |
| | | Compound (C) | GMA | 10.5 | 10.7 | 10.7 | 10.5 | 10.7 |
| | | | NK OLIGO EA1010N | 5.7 | 5.8 | 5.8 | 5.7 | 5.8 |
| | | Radical Polymerization | Perhexa CS | 0.3 | 0.3 | 0.3 | 0.3 | 0.3 |
| | | Initiator (D) | | | | | | |
| | | Acid Generator (E) | Sanaid SI-60L | 2.9 | 1.0 | 1.0 | 2.9 | 1.0 |
| | | Release Agent (F) | Zinc stearate GP | 3 | 3 | 1 | 3 | — |
| | | Talc | HA | — | — | — | 3 | — |

| | Mass Content Rate Wf of Reinforcing Fiber (G) [wt %] | 70.4 | 70.4 | 70.4 | 64.3 | 67.3 |
|---|---|---|---|---|---|---|
| Viscosity of the Composition for a Fiber-Reinforced Composite Material [mPa · s] | | 834 | 851 | 755 | 890 | 645 |
| Viscosity after Storage at 25° C. for 72 hours of the Composition for a Fiber-Reinforced | | 850 | 870 | 770 | 921 | 657 |
| Composite Material [mPa · s] | | | | | | |
| Fiber- | Continuous Pultrudability | ⊙ | ⊙ | ◯ | ⊙ | X |
| Reinforced | Tg [° C.] | 175 | 158 | 147 | 182 | 158 |
| Composite | E′ (30° C.) [×10¹⁰ Pa] | 7.4 | 7.3 | 6.8 | 7.5 | 6.6 |
| Material | E′ (250° C.) [×10¹⁰ Pa] | 6.6 | 6.4 | 5.5 | 6.6 | 5.4 |
| | E′ (Tg − 10° C.) [×10¹⁰ Pa] | 6.8 | 6.7 | 6.3 | 6.9 | 5.4 |
| | E′ (Tg + 10° C.) [×10¹⁰ Pa] | 6.5 | 6.4 | 6.0 | 6.6 | 5.2 |
| | E′ Reduction Rate (%) | 4.4 | 4.5 | 4.8 | 4.3 | 3.7 |
| | Linear Expansion Coefficient (fiber direction) [ppm/° C.: 30 to 200° C.] | −0.6 | −1.1 | −0.4 | −0.4 | −1.0 |
| | Linear Expansion Coefficient (perpendicular-to-fiber direction) [ppm/° C.: | 41.8 | 41.0 | 48.0 | 41.2 | 41.3 |
| | 30 to 200° C.] | | | | | |

As shown in Table 1, the compositions (Examples) for fiber-reinforced composite materials according to the present invention enabled the continuous production by a pultrusion method, and were excellent in the continuous pultrudability.

Further the compositions (Examples) for fiber-reinforced composite materials according to the present invention can be fully cured by heating in a very short time, and had a high curing speed.

Further the fiber-reinforced composite materials (Examples) produced using the compositions for fiber-reinforced composite materials according to the present invention had high glass transition temperatures, and high elastic moduli even at a high temperature of 250° C., and small decreases (E′ reduction rates) in elastic moduli at temperatures of below and above the glass transition temperatures (Tg±10° C.), thus giving excellent heat resistance. Further the fiber-reinforced composite materials were materials having low linear expansion coefficients.

Further in the compositions (Examples) for fiber-reinforced composite materials according to the present invention, there were almost no difference between the viscosities right after their preparation and the viscosities after the compositions were stored at 25° C. for 72 hours, and thus, the compositions were excellent in the work stability.

Here, components used in Examples and Comparative Examples were as follows.

### [Radically Polymerizable Compounds (A)]

IRR214-K: dimethyloldicyclopentane diacrylate (manufactured by Daicel-Cytec Co., Ltd., molecular weight: 304, the number of acryloyl groups in one molecule: two, functional group equivalent weight: 152)

DPHA: dipentaerythritol hexaacrylate (manufactured by Daicel-Cytec Co., Ltd., molecular weight: 578, the number of acryloyl groups in one molecule: six, functional group equivalent weight: 96.3)

### [Cationically Polymerizable Compounds (B)]

Celloxide 2021P: 3,4-epoxycyclohexylmethyl(3,4-epoxy)cyclohexanecarboxylate (manufactured by Daicel Corp., molecular weight: 252, the number of epoxy groups in one molecule: two, functional group equivalent weight: 126)

EHPE3150: a 1,2-epoxy-4-(2-oxiranyl)cyclohexane adduct of 2,2-bis(hydroxymethyl)-1-butanol (manufactured by Daicel Corp., functional group equivalent weight: about 100)

### [Compounds (C)]

GMA: glycidyl methacrylate (manufactured by NOF Corp., molecular weight: 142, the number of methacryloyl groups in one molecule: one, the number of epoxy groups in one molecule: one, functional group equivalent weight: 142)

NK OLIGO EA1010N: bisphenol A epoxy half acrylate (manufactured by Shin-Nakamura Chemical Co., Ltd., molecular weight: 412, the number of acryloyl groups in one molecule: one, the number of epoxy groups in one molecule: one, functional group equivalent weight: 412)

### [Radical Polymerization Initiators (D)]

Perhexa CS: 1,1-di(t-butylperoxy)cyclohexane (manufactured by NOF Co., Ltd.,)

### [Acid Generators (E)]

Sanaid SI-60L: an aromatic sulfonium salt (manufactured by Sanshin Chemical Industry Co., Ltd.,)

### [Release Agents (F)]

Zinc stearate GP: zinc stearate (manufactured by NOF Corp.)

### [Talc]

HA: Talc HA (manufactured by Sobue Clay Co., Ltd.)

### INDUSTRIAL APPLICABILITY

By using the composition for a fiber-reinforced composite material according to the present invention, the fiber-reinforced composite material can be obtained. The fiber-reinforced composite material can preferably be used, for example, as a material for constructions such as: fuselages, main wings, tail assemblies, mobile wings, fairings, cowls, doors and the like of aircrafts; motor cases, main wings and the like of spacecrafts; body structures of artificial satellites; automobile parts such as chassis of automobiles; body structures of railroad vehicles; body structures of bicycles; body structures of marine vessels; blades of wind power generators; pressure vessels; fishing rods; tennis rackets; golf shafts; robot arms; and cables (for example, core materials of cables (particularly, core materials of electric wire to be used as aerial wire).

1. A composition for a fiber-reinforced composite material, comprising: a radically polymerizable compound (A); a cationically polymerizable compound (B); a compound (C) having a radically polymerizable group and a cationically polymerizable group in one molecule thereof; a radical polymerization initiator (D); an acid generator (E); and a release agent (F),
wherein the radically polymerizable compound (A) is a compound having not less than two radically polymerizable groups in one molecule thereof, and having a functional group equivalent weight of the radically polymerizable group of 50 to 300.

2. The composition for a fiber-reinforced composite material according to claim 1, wherein the cationically polymerizable compound (B) is at least one compound selected from the group consisting of epoxy compounds, oxetane compounds and vinyl ether compounds.

3. The composition for a fiber-reinforced composite material according to claim 1, wherein the cationically polymerizable compound (B) is an alicyclic epoxy compound.

4. The composition for a fiber-reinforced composite material according to claim 1, wherein the cationically polymerizable compound (B) is a compound having not less than two cationically polymerizable groups in one molecule thereof, and having a functional group equivalent weight of the cationically polymerizable groups of 50 to 300.

5. The composition for a fiber-reinforced composite material according to claim 1, wherein a proportion (weight ratio) [(A)/(B)] of the radically polymerizable compound (A) to the cationically polymerizable compound (B) is 30/70 to 85/15.

6. The composition for a fiber-reinforced composite material according to claim 1, wherein the radically polymerizable compound (A) comprises an alkylene oxide-modified monomer having not less than four radically polymerizable groups in one molecule thereof.

7. The composition for a fiber-reinforced composite material according to claim 1, wherein the compound (C) is a compound having a functional group equivalent weight of the cationically polymerizable group of 50 to 500, and a functional group equivalent weight of the radically polymerizable group of 50 to 500.

8. The composition for a fiber-reinforced composite material according to claim 1, wherein the content of the compound (C) is 10 to 70 parts by weight based on 100 parts by weight of the total amount of the radically polymerizable compound (A) and the cationically polymerizable compound (B).

9. The composition for a fiber-reinforced composite material according to claim 1, wherein the content of the radical polymerization initiator (D) is 0.01 to 10 parts by weight based on 100 parts by weight of the total amount of the radically polymerizable compound (A), the cationically polymerizable compound (B) and the compound (C).

10. The composition for a fiber-reinforced composite material according to claim 1, wherein the content of the acid generator (E) is 0.1 to 20 parts by weight based on 100 parts by weight of the total amount of the radically polymerizable compound (A), the cationically polymerizable compound (B) and the compound (C).

11. The composition for a fiber-reinforced composite material according to claim 1, wherein the content of the release agent (F) is 1 to 8 parts by weight based on 100 parts by weight of the total amount of the components (A) to (E).

12. The composition for a fiber-reinforced composite material according to claim 1, wherein the release agent (F) is a higher fatty acid having 10 to 30 carbon atoms or a derivative thereof.

13. The composition for a fiber-reinforced composite material according to claim 1, wherein the release agent (F) is a metal stearate compound.

14. The composition for a fiber-reinforced composite material according to claim 1, wherein the elastic modulus E′ at 250° C. of a cured material obtained by curing the composition is not less than 1×10⁸ Pa.

15. The composition for a fiber-reinforced composite material according to claim 1, wherein the reduction rate of the elastic modulus E′ of a cured material obtained by curing the composition as calculated by the following expression is not more than 50%:
a reduction rate of the elastic modulus E′ (%)=100×(a−b)/a
wherein a represents an elastic modulus (Pa) of the cured material at a temperature (° C.) of (the glass transition temperature thereof−10° C.); and b represents an elastic modulus (Pa) of the cured material at a temperature (° C.) of (the glass transition temperature thereof+10° C.).

16. The composition for a fiber-reinforced composite material according to claim 1, wherein the degree of curing [which is measured by differential scanning calorimetry] of a cured material obtained by curing the composition by a heat treatment at 220° C. for 2 min is not less than 80%.

17. A prepreg, being formed by impregnating a composition for a fiber-reinforced composite material according to claim 1 into a reinforcing fiber (G).

18. The prepreg according to claim 17, wherein the fiber mass content rate (Wf) of the reinforcing fiber (G) is 50 to 90% by weight.

19. The prepreg according to claim 17, wherein the reinforcing fiber (G) is at least one selected from the group consisting of carbon fibers, glass fibers and aramid fibers.

20. A fiber-reinforced composite material, being obtained by curing a prepreg according to claim 17.
